(19) United States
(12) Patent Application Publication
(10) Pub. No.: US 2025/0239860 A1
(43) Pub. Date: Jul. 24, 2025

(54) Method for Operating an Electrical Distribution Systems

(71) Applicant: Siemens Sanayi ve Ticaret A.S., Istanbul (TR)

(72) Inventors: Erk DURSUN, Ankara (TR); Suheyl HEPSEN, McKinney, TX (US)

(21) Appl. No.: 19/029,822

(22) Filed: Jan. 17, 2025

(30) Foreign Application Priority Data
Jan. 19, 2024 (EP) 24152766

(51) Int. Cl. H02J 3/38

(52) U.S. Cl. CPC H02J 3/388; H02J 2203/10; H02J 2203/20

(57) ABSTRACT

A method for operating an electrical distribution systems includes generating a graphical structure for an electrical distribution system, and using the generated graphical structure for controlling the electrical distribution system, wherein generation of the graphical structure for the electrical distribution system includes generating a physical topology showing the islands and switch bays of the electrical distribution system as well as topology connections between the islands and switch bays, where the islands include a plurality of first components and the switch bays include a plurality of second components, where the method further includes storing the events of components of the islands and switch bays as timestamps.

### BACKGROUND OF THE INVENTION

### 1. Field of the Invention

The present invention relates to an operational method that uses a graphical structure for electrical distribution systems.

### 2. Description of the Related Art

Electrical distribution systems have very large and complicated systems that have a mostly radial or lightly mesh structure. Traditional operation of a distribution grid based on the energy flow is from the root node (connection point between transmission system and distribution system) to the leaf nodes (energy consumers). The flow is controlled by equipment called switches. The status of switches changes the flow direction as a result of changing the grid structure.

The nature of radial structure, in case of any failure, is such that some of the leaf nodes separate from energized island and cannot feed from the root node. This constitutes an outage for consumers, and it has some consequences for a utility company. Firstly, the utility company cannot sell the energy to deenergized consumers during the outage. Another concern is many countries have regulations related with outages, where the utilities are forced to pay penalties to the customers that are effected by the outages. Finally, the operation metrics, which are used in the performance evaluation of utilities, are highly sensitive for outage duration and frequencies.

As a result of these concerns, utilities are use situational awareness systems that allow supervision and control of the system in real-time. A full model of static network representation is modelled into software systems and fed by real-time measurements provided by sensors/crews on the field. System operators use the information from the system and orchestrate the grid structure (open/close switches) to be able to isolate/restore consumers that are effected from faults.

The main part of situational awareness is called a topology processor. A topology processor mainly consist of an online representation of grid connectivity and switch positions, plus domain specific traverse algorithms works on that representations. The results of the topology processor are used by many decision support applications. In order to be able to react to topology changes in a reasonable amount of time, the performance of the topology processor is highly demandable.

Conventional topology processors for distribution management systems are designed to handle medium voltage networks that can be provided as a middleware layer between a supplier layer and a consumption layer. The main constraint to a model low voltage network is related to sizing. On the other hand, medium voltage networks are significantly smaller than low voltage networks, but are the main supplier for several of low voltage networks. This means that any possible failure on the medium voltage side will effect multiple low voltage networks in parallel. For this reason, the importance of modelling and supervising the medium voltage network have been essential.

EP application no. 3 682 517 A1 discloses a method for identifying the topology of an electric power network. According to this document, by using metering units, the load of the system is estimated. However, according to this document, the graphical structure of the electrical distribution system cannot be generated in detail.

### SUMMARY OF THE INVENTION

In view of the foregoing, it is an object of the present invention is to provide a method for operating electrical distribution systems.

It is also an object of the present invention is to provide an operational method that uses a graphical structure of the electrical distribution systems.

It is a further object of the present invention is to provide an operational method that uses a graphical structure with timestamps.

These and other objects and advantages are achieved in accordance with the invention by a method for operating electrical distribution systems comprising generating a graphical structure for an electrical distribution system, and using the generated graphical structure to control the electrical distribution system, where generating the graphical structure for the electrical distribution system comprises generating a physical topology showing the islands and switch bays of the electrical distribution system as well as topology connections between said islands and switch bays, where the islands comprise a plurality of first components and the switch bays comprise a plurality of second components. The method further comprises storing the events of the first or second components of the islands and switch bays at least as timestamps. The respective first and second components are configured to generate respective events during operation, where the events include respective data regarding the operation of the respective first or second component and respective timestamps with the time of the event occurred.

In accordance with the present invention, in addition to the physical topology of the electrical distribution system, events of components of the electrical distribution system are used to generate the graphical structure. As a result, the graphical structure can be used by a data provider for further analytic applications, or the output of these applications can be used for postmortem analysis or to determine the effects of the investment plans to the operation metrics. Accordingly, electrical distribution can be controlled more accurately and in actual timewise manner.

Events can be, for instance, the registration process of a component within the network, e.g. at the topology processor, recognized and captured by a respective timestamp.

The topology processor can establish or update a graphical structure in accordance with the registered components during the operation of the electrical distribution system network, and not by load profiles as usual performed in the prior art

Such a registration can be performed by adding components to the graph or removing components from the graph, stored e.g. in the memory of the topology processor.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The drawing shows an exemplary embodiment of the invention, in which:

FIG. 1 shows an exemplary graphical structure generated in accordance with the method of the invention;

FIG. 2 shows an alternative exemplary graph structure showing switch details; and

FIG. 3 is a flowchart of the method in accordance with the invention.

### DETAILED DESCRIPTION OF THE EXEMPLARY EMBODIMENTS

Electrical energy providers are expected to provide electricity to users all the time. However, due to unexpected problems, such as a dramatic change in load or equipment errors, it is not possible to supply electricity to all users all the time. In order to at least determine the problems and analyze faults, graphical structures (topology models) of the electrical distribution system can be used. Therefore, in accordance with the present disclosure, an operation method that uses a graphical structure for electrical distribution systems is provided.

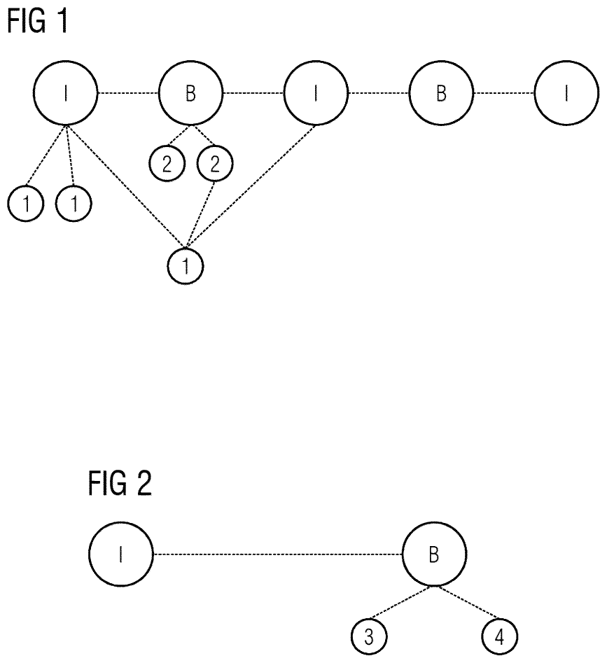

With reference to FIGS. 1 and 2, the invention method comprises generating a graphical structure for an electrical distribution system, and using the generated graphical structure to control the electrical distribution system. The generation of the graphical structure for the electrical distribution systems of the present disclosure comprises generating a physical topology showing the islands I and switch bays B of the electrical distribution system as well as topology connections between the islands I and switch bays B, where the islands I comprise a plurality of first components 1 and the switch bays B comprise a plurality of second components 2. The inventive method further includes storing the events of components of the islands I and switch bays B as timestamps.

In an exemplary embodiment, the inventive method is used for controlling an electrical distribution system. In order to do so, a graphical structure of a low or medium voltage network is generated. In the presently contemplated embodiment, a physical topology of the low or medium voltage network is initially generated by a topology processor. The physical topology shows islands I, switch bays B and topology connections between them. The islands I may comprise nodes, lines, bus bars, and a load as the first component 1. Similarly, the switch bays B comprise switches, breakers, isolators, and fuses as second components 2. The first components 1 may be connected to each other as well as to the second components 2. Generation of the physical topology is known in the art. In accordance with the disclosed embodiments, in addition to the physical topology, events of components of the islands I and switch bays B are stored as timestamps. When the timestamps are added to the generated physical topology, the graphical structure is generated. The timestamps enable use of the generated graphical structure to calculate the energization state of the low or medium voltage network at any given time, tracking the physical evolution of the low or medium voltage network over time. Furthermore, the generated graphical structure may be used as a data provider for further analytic applications, or the output of these applications can be used for post-mortem analysis or for determining the effects of the investment plans to the operation metrics. In another exemplary embodiment, the generated graphical structure is used for energization analysis. Energization analysis is basically a traversal calculation starting from energy source(s) through all accessible equipment by considering switch states. Although, It is common for a current time instance since the graphical structure knows the current states of the component and the switch state is processed as time interval of event, the inventive methodology can be used to find energized equipment for a given time interval. In another words, in accordance with the disclosed embodiments, it possible to proceed to a desired time interval and examine the graphical structure of the time interval. Furthermore, owing to the island I and bay B structure of the present disclosure, the total number of the nodes to be used in the traversal calculation is reduced. This is especially advantageous for the low voltage networks, because they normally have a large number of nodes. In other words, in accordance with the present disclosure, the traversal calculation for the low and medium voltage networks is performed in an easier way.

In a preferred embodiment of the inventive method, the events of the first and second components are generated at predefined time intervals, which are differently defined for each of the first and second components when storing the events of the first or second components 1, 2 of the islands I) and switch bays B as timestamps. The predefined time intervals are time interval properties adding and removing time regarding the event of the respective components. In an exemplary embodiment, a first switch 3 and a second switch 4 of a switch bay B, shown in FIG. 2, are responsible for controlling connections of different first components 1 of an island I. In the present embodiment, when a first component 1 is connected to an electrical distribution system through the first switch 3, the timestamp for the addition is stored as a first parameter (showing a connection time, for example, time 0). As long as the first component 1 is kept connected (first switch 3 is in closed state), a second parameter (showing disconnecting time) is kept as infinite. When the first component 1 is disconnected by the first switch 3, a second parameter is updated as the opening time of the first switch 3. Preferably, when storing the events of components of the islands I and switch bays B as timestamps, arrays are used for storing the timestamps. As a result, when the first switch 3 is again closed, the connection time of the first component 1 is stored as a new first parameter. Under the assumption that the first switch 3 is closed in time 0, the timestamp of the first switch 3 initially becomes “[0, ∞]”. If the first switch 3 is opened at time t1 and closed again at time t2, the timestamp then becomes “[0, t1], [t2, ∞]”. Owing to the timestamp, it is possible to determine at which times the first switch 3 is open and at closed positions. Therefore, it is possible to determine whether the first component 1 is connected to electrical distribution system at certain times. This operation is also performed by the second switch 4 and further switches of the switch bay B. In the presently contemplated embodiment, for each switch, the timestamp information is stored with the id of the related switch. Therefore, the timestamp of the first switch may become “SW1=[[, t1], [t2, ∞]]”. In this embodiment, since arrays are used for storing the timestamps, the timestamps can be used data structures implemented in computers having processors and memory. In other words, the arrays can be used as data flows, and thus can be used by computer applications executing on computers. Accordingly, timestamp data can be analyzed by the computer applications with ease and a high level of accuracy.

In another preferred embodiment, when a first component 1 of an island I is disconnected from the electrical distribution system, the generated physical topology is updated by removing a related component from the network of the electrical distribution system and consequently from the graphical structure. As a result, the physical topology is constantly changing. In accordance with the presently contemplated embodiment, only the components connected to electrical distribution system are in the physical topology. As a result, the physical topology is kept as simple as possible. However, it is possible to re-connect the first component 1 to the electrical distribution system. Accordingly, events of the first component 1 are kept as saved. Therefore, it is possible to track whenever a first component 1 is connected to electrical distribution system, without increasing the complexity of the physical topology. Accordingly in accordance with the presently contemplated embodiment, when a first component 1 of an island I is connected to the electrical distribution system, the generated physical topology is updated by adding related component to the network of the electrical distribution system and consequently to the graph structure.

In accordance with the disclosed embodiments, in addition to the physical topology of the electrical distribution system, events of components of the electrical distribution system are used for generating the graphical structure. As a result, the graphical structure can be used by a data provider for further analytic applications, or the output of these applications can be used for postmortem analysis or to determine the effects of the investment plans to the operation metrics. Accordingly, the electrical distribution can be controlled more accurately.

In another preferred embodiment, the events include further data of the operation of the respective first or second component with respect to the respective timestamp, and the data are considered when generating the graphical structure. Thus, the data, e.g., connection data between network nodes or load profiles of network components, can be considered at the graphical structure to add further dynamic data regarding the operation of the network into the graph.

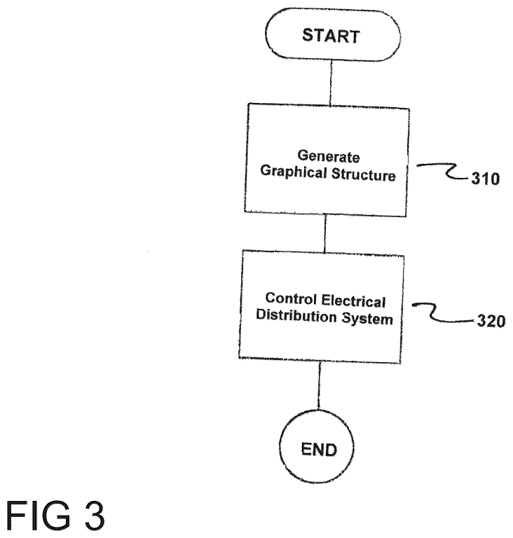

FIG. 3 is a flowchart of the method for operating an electrical distribution systems. The method comprises a) generating a graphical structure for an electrical distribution system, as indicated in step 310.

Next, b) the electrical distribution system is controlled based on the generated graphical structure, as indicated in step 320.

In accordance with the method, generating the graphical structure for the electrical distribution system comprises c) generating a physical topology showing islands I and switch bays B of the electrical distribution system and showing topology connections between said islands I and the switch bays B, where the islands I comprising a plurality of first components 1 and the switch bays B comprises a plurality of second components 2, the first and second components 1, 2 are each respectively configured to generate respective events during operation, and the events including respective data regarding operation of the respective first or second component 1, 2 and respective timestamps indicating a time of an occurrence of an event. Generating the graphical structure for the electrical distribution system additionally includes d) storing the events of the first or second components 1, 2 of the islands I and switch bays B at least as timestamps.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for operating an electrical distribution systems, the method comprising:
a) generating a graphical structure for an electrical distribution system; and
b) controlling the electrical distribution system based on the generated graphical structure;
wherein said generating the graphical structure for the electrical distribution system comprises:
c) generating a physical topology showing islands and switch bays of the electrical distribution system and showing topology connections between said islands and the switch bays, the islands comprising a plurality of first components and the switch bays comprising a plurality of second components, the first and second components each being respectively configured to generate respective events during operation, and the events including respective data regarding operation of the respective first or second component and respective timestamps indicating a time of an occurrence of an event; and
d) storing the events of the first or second components of the islands and switch bays at least as timestamps.

2. The method according to claim 1, wherein the events of the first and second components are generated by predefined time intervals, which are defined differently for each of the first and second components during step d).

3. The method according to claim 1, wherein arrays are utilized for storing the timestamps during step d).

4. The method according to claim 1, further comprising:
removing a related component from the graph structure when the first component of the island is disconnected from the electrical distribution system to update the generated physical topology.

5. The method according to claim 1, further comprising:
adding a related component to the graph structure when the first component of the island is connected to the electrical distribution system to update the generated physical topology.

6. The method according to claim 1, wherein the method is performed by a topology processor.

7. The method according to claim 1, wherein the events include further data of the operation of the respective first or second component with respect to the respective timestamp, and the data are considered during generation of the graphical structure.
